(19) United States
(12) Patent Application Publication
(10) Pub. No.: US 2013/0196688 A1
(43) Pub. Date: Aug. 1, 2013

(54) GPS ODOMETER

(71) Applicants: Ping-Han Lu, Taipei City (TW); Ying-Lin Lai, Taipei (TW)

(72) Inventors: Ping-Han Lu, Taipei City (TW); Ying-Lin Lai, Taipei (TW)

(73) Assignee: TOMTOM INTERNATIONAL B.V., Amsterdam (NL)

(21) Appl. No.: 13/877,731

(22) PCT Filed: Mar. 28, 2011
(86) PCT No.: PCT/EP2011/054686

§ 371 Date: Apr. 4, 2013

Related U.S. Application Data
(60) Provisional application No. 61/389,284, filed on Oct. 4, 2010.

(30) Foreign Application Priority Data
Jan. 5, 2011 (TW) 100100382

(51) Int. Cl. H04W 4/02

(52) U.S. Cl. CPC H04W 4/02
USPC 455/456.1

(57) ABSTRACT

A system is provided that is configured to be transported, carried or worn by a user, such as a portable personal training device or sports watch. The system comprises means for determining the location of the user at a plurality of times during a journey from a first location to a second location, such as a GPS receiver. The system further comprises means for determining a motion state of the user at a plurality of times during the journey. The means can include an accelerometer, and can also utilise data obtained from a GPS receiver. The system further comprises means for determining the distance travelled by the user during at least a portion of the journey using the plurality of determined locations and the plurality of determined motion states, such that the system functions as an odometer.

### FIELD OF THE INVENTION

This invention relates to mobile devices having means for determining and tracking the device's location. Illustrative embodiments of the invention relate to portable training devices, e.g. devices that can be worn by runners, cyclists, etc, which can track and record the pace of the user at particular moments during a workout and/or the distance covered by the user during the workout.

### BACKGROUND OF THE INVENTION

Portable navigation devices (PNDs) that include GNSS (Global Navigation Satellite Systems) signal reception and processing functionality are well known and are widely employed as in-car or other vehicle navigation systems. Such devices include a GNSS antenna, such as a GPS antenna, by means of which satellite-broadcast signals, including location data, can be received and subsequently processed to determine a current location of the device. The PND device may also include electronic gyroscopes and accelerometers which produce signals that can be processed to determine the current angular and linear acceleration, and in turn, and in conjunction with location information derived from the GPS signal, velocity and relative displacement of the device and this vehicle in which it is typically mounted. Such sensors are most commonly provided in in-vehicle navigation systems, but may also be provided in the PND device itself.

In recent years, the use of GPS has started to be used for pedestrian and outdoor applications. For example, sports watches that include GPS antennas have started to be used by joggers, runners, cyclists and other athletes and outdoor enthusiasts as a means to obtain real-time data of their speed, distance travelled, etc. The GPS data is also typically stored on such devices such that it can be analysed after the athlete has finished their activity, e.g. in some cases by transferring the collected data to a computer or website to be displayed on a digital map.

In conventional PNDs, vehicle speed and distance is often calculated using the measured ground speed of the vehicle obtained from the GNSS signals, and more specifically derived from the carrier phase tracking loops. For example, the distance travelled by the vehicle between two epochs (or specific instants in time when an updated GPS signal is received) can be calculated by integrating, either numerical or vector as appropriate, the vehicle's velocity vector over time. The well-known errors experienced with GPS signals, such as the multi-path effect, can also often be mitigated or at least reduced in vehicle navigation through various filtering techniques, such as Kalman filtering and map matching.

As will be easily appreciated, the dynamical behaviour of pedestrians and other outdoor enthusiasts is very different from that of vehicles. For example, vehicles are limited in most circumstances to travel on a set road network, and thus will usually only experience limited and predictable changes in direction. In contrast, pedestrians, cyclists, etc have no such restrictions (or are at least subject to significantly fewer restrictions) and thus have more complex dynamical movements. Furthermore, in dense urban environments, pedestrians will also often walk on pavements (or sidewalks), and thus will typically be closer to buildings than vehicles. This has the effect of reducing satellite visibility, thereby degrading horizontal dilution of precision (HDOP).

In view of these differences in dynamical behaviour, previous attempts have been made to determine the distance travelled by pedestrians using other methods such as a step counter (or pedometer), foot-pad sensors (e.g. accelerometers) and tachometers. Step counters and foot-pad sensors do not have a high-degree of accuracy, typically even in the best conditions only an accuracy of 5% can be achieved. Tachometers have a better accuracy, however, they are difficult to implement.

It would therefore be desirable to provide a mobile device that can track a user's movement and at least measure the distance travelled by the user with a higher degree of accuracy.

### SUMMARY OF THE INVENTION

According to a first aspect of the present invention, there is provided a system configured to be transported, carried or worn by a user, comprising:

means for determining the location of the user at a plurality of times during a journey from a first location to a second location;

means for determining a motion state of the user at a plurality of times during the journey; and

means for determining the distance travelled by the user during at least a portion of the journey using the plurality of determined locations and the plurality of determined motion states.

According to a second aspect of the present invention, there is provided a method of determining the distance travelled by a user during at least a portion of a journey from a first location to a second location using a system configured to be transported, carried or worn by the user, the method comprising:

determining the location of the user at a plurality of times during the journey;

determining a motion state of the user at a plurality of times during the journey; and

using the plurality of determined locations and the plurality of determined motions states to determine the distance travelled by the user.

In the present invention, a system is provided that is arranged to be transported, carried or worn by a user. The system can comprise a single device (containing one or more sensors) or it may comprise a plurality of devices and sensors that are worn or carried about a person's body. In embodiments wherein the sensors are external from a central body, e.g. a mobile device, then preferably the central body comprises means for receiving data from the sensors.

In a preferred embodiment, the system comprises a mobile or portable device that can be carried by a user as he or she travels from one location to another. The mobile device can be arranged so as to be carried by the user, such as being attached to the user's arm or wrist, or simply by being placed in a pocket or other suitable receptacle (e.g., a specially designed holder or case). In other embodiments, the mobile device can be arranged so as to be transported carried by a user. For example, the mobile device can be attached to a vehicle being used by the user, e.g. a bicycle, canoe, kayak or other similar vehicle. The mobile device could also be attached to an object being pushed or pulled by a user, such as a child-carrying buggy. Such mobile devices are commonly referred to as portable personal training devices.

It should be appreciated that such mobile devices, i.e. portable personal training devices, preferably do not include navigation functionality as found in vehicle PNDs. For example, portable personal training devices typically, and in preferred embodiment of the present invention, do not include map data stored within a memory of the device or processing means that can use the map data to determine a route between a first location (or “origin”) and a second location (or “destination”) and provide suitable navigation (or guidance) instructions.

The system comprises means for tracking the location of the user as he or she moves from one location to another. As will be discussed in more detail below, the location determining means preferably comprises a satellite navigation receiver for receiving satellite signals indicating the position of the user a particular point in time, and which receives updated position information at regular intervals.

The system further comprises means for determining a motion state of the user, such as one or more motion sensors, which provides an indication of the dynamical movement being performed or experienced by the user.

The locations and determined motion states of the user obtained (or received) by the device are used in the present invention to estimate the distance that has been travelled by the user during their journey (or workout). The term “distance”, unless the context requires otherwise, can be a 2D distance, i.e. the distance travelled at a constant elevation, or a 3D distance, i.e. the absolute distance travelled taking account of movement along the ground and all changes in height. The mobile device therefore functions at least in part as an odometer.

It has been recognised that taking account of the motion state of the user and/or device throughout the journey permits a significantly more accurate distance estimate to be calculated, when compared to only using the individual determined locations. This is due, for example, to the inherent non-predictable errors associated with the determined locations, in particular when they are determined using GPS, where errors are typically slowly time varying in nature, and can include: ionospheric effects; satellite ephemeris errors; and satellite clock model errors.

As discussed above, the system comprises a means for determining the location of the device at a plurality of times during a journey. The location determining means can comprise any suitable device as desired. For example, latitude and longitude coordinates can be determined using devices that can access and receive information from WiFi access points or cellular communication networks. Preferably, however, the location determining means comprises a global navigation satellite systems (GNSS) receiver, such as a GPS receiver, for receiving satellite signals indicating the position of the receiver (and thus user) at a particular point in time, and which receives updated position information at regular intervals.

Preferably, the GNSS receiver comprises a patch antenna or helical antenna, but it may comprise any other type of antenna capable of receiving satellite signals. The antenna is preferably at least partially encased or contained within a housing of the mobile device.

In a preferred embodiment, new location information, i.e. the geographic location of the device, is received at a rate of 0.5 Hz or greater, preferably at a rate of 1 Hz or greater, such as up to a rate of 20 Hz. In a particularly preferred embodiment, the new location information is received at a rate of 1 Hz. As known in the art, the location information comprises at least longitude and latitude, and can preferably also include elevation.

The system further comprises means for determining a motion state of the user and/or device at a plurality of times during the journey. In a preferred embodiment, the motion state determining means comprises one or more sensors that can detect movement of the device. For example, the motion state determining means can comprise one or more accelerometers for determining the magnitude and direction of the acceleration, e.g. in at least two, and preferably three axes. The accelerometers can be single-axis accelerometers or multi-axis accelerometers. For example, in a particular preferred embodiment, the mobile device comprises a three-axis accelerometer. In other embodiments, the motion state determining means can also comprise other sensors, in addition to or as an alternative to the one or more accelerometers, such as gyroscopes, compasses, inertial sensors, etc. The motion state detecting means therefore detects changes in movement and/or direction of the user, directly (when the device is worn or carried by the user) or indirectly (when the device is transported by the user).

The system may further comprise (and thus the mobile device may further have access to data from) one or more external motion sensors, e.g. for detecting motion of the user. For example, in a preferred embodiment, the mobile device may comprise communication means for at least receiving data from a footpad sensor (worn by the user). The foot pad sensor, as known in the art, may comprise a piezoelectric sensor (accelerometer), e.g. that is positioned in the sole of the user's shoe and detects each time the shoe strikes the ground.

The motion state of the user and/or device can be determined at any suitable time and/or rate during the course of the journey. However, in a preferred embodiment, the motion state is determined at a rate of 0.5 Hz or greater, preferably at a rate of 1 Hz or greater, such as up to rate of 20 Hz, and most preferably at either 1 Hz, 5 Hz or 10 Hz.

In a preferred embodiment, the motion state of the user and/or device is determined at the same rate, or a faster rate, as the current location of the device is determined by the location determining means, such that the motion state of the user is known at least at each determined location. Preferably, the location determining means and the motion state determining means are arranged to operate in an synchronous manner.

In a preferred embodiment, the motion state determining means preferably further uses data received from the location determining means, e.g. the GNSS receiver, in addition to the data obtained from the one or more movement sensors. For example, the motion state determining means can further utilise one or more of: satellite signal strength (e.g. the “relative signal strength indicator” (RSSI)); expected position errors (e.g. the “expected horizontal position error” (EHPE)); distance travelled (e.g. the distance travelled between two epochs as determined from the location provided by the GNSS receiver—“delta distance”); and measured speed (e.g. the speed over ground (SOG)).

In a preferred embodiment, a plurality of different motion states are predefined (e.g. and stored) in the device, and the motion state determining means is configured to identify which of the plurality of motion states the user and/or device is in at the time in the question. The plurality of motion states can comprise states based on a speed of travel and/or the type of directional movement being performed. In other words, the different states are used to reflect differences in speed and/or direction of travel that the user can be expected to make while using the device.

For example, the predefined motion states can include: “standstill”—describing times when the user and/or device is not moving; “walking”—describing times when the user is moving at a walking pace; “running”—describing times when the user is moving at a running pace; “vehicle”—describing times when the user is travelling in a vehicle, such as a car; “linear”—describing times when the user is moving in a straight line; and “circular”—describing times when the user is moving in a circular motion.

It will be understood that other motion states can be defined as desired. For example, instead of defining only one “running” state, a plurality of “running” or “walking” states could be defined to distinguish between, e.g., jogging and sprinting. Motion states could also be defined for other outdoor activities, e.g. cycling, skiing, kayaking, etc.

As will be appreciated, depending on how the different motion states are defined, the motion state determining means can determine that the user and/or device is in only one of the plurality of motion states or the user and/or device may be determined to be simultaneously in two or more of the plurality of motion states.

In the present invention, the plurality of determined locations for the mobile device and the determined motion states are then used to determine the distance travelled by the user. The means for determining the distance comprises a processing resource, such as one or more (suitably programmed) processors.

As will be discussed in more detail below, the step of determining the distance travelled by the user preferably comprises assessing the determined locations of the device based one or more criteria and selecting those locations that meet the required criteria. In other words, an adaptive pre-down sampling is performed of the determined geographic locations to determine a set of selected, or “critical”, locations which are subjected to further processing. Preferably, the selected locations are subjected to a smoothing process, e.g. in which one or more “smooth” functions or curves are fitted to the data as appropriate. The function or functions generated by the smoothing process are preferably sampled at a rate desired by the user (e.g. in a post-down sampling step) to generate a series of “smoothed” geographic locations that are indicative of the journey taken by the user, and which can be used to determine the distance travelled.

The determined geographic locations that are assessed based on one or more criteria can comprise the locations in the form received, e.g. the longitude and latitude positions obtained from the GNSS receiver. In a preferred embodiment, however, the locations that are assessed are firstly modified based on whether the device is determined to be in a stationary position or not.

For example, as those skilled in the art will appreciate, due to the errors associated with GPS signals, even if a device with a GPS receiver in reality remains stationary for a period of time, the locations output by the GPS receiver may show that the device has been in continual movement and thus has moved a certain, albeit possibly small, distance.

Accordingly, in a preferred embodiment, when the motion state determining means, e.g. accelerometer(s), determines that the user/device is stationary, e.g. in a “standstill” state, the last determined location when the device was moving is used as the location of the device until the motion state determination means indicates the device is moving again. In other words, the location of the device is “locked”, and the location only updated again when the device is determined to no longer be stationary.

Preferably, the determined locations obtained from the location determining means, which may or may not have been adjusted in the manner described above, are sampled at least according to the determined motion state of the user. Therefore, in a preferred embodiment, the mobile device comprises means for sampling the locations received from the location determining means.

Preferably, each of the predefined motion states and/or each combination of predefined motion states has an associated sampling rate (e.g. that is suitable for the type of motion being performed by the user). The sampling rates can be selected as desired, however, in a preferred embodiment at least some, and preferably all, of the sampling rates are different.

This sampling of the locations is performed to take account of the many possible users of the device and the varying speeds that they may be travelling. For example, the device may be used by walkers travelling at relatively slow speeds of a few km per hour to cyclists who might be travelling at speeds of up to 50 km per hour. The device may also be used by users riding powered vehicles, and who therefore might be travelling at even greater speeds. As will be appreciated, a slower sampling rate is typically required at slower speeds otherwise errors in the GPS position will typically lead to a significant increase in the estimated distance travelled by the user when compared to the actual real-life distance. Similarly, a more accurate distance can be estimated with fewer determined locations when the user is moving in a straight line, i.e. not changing direction. In contrast, if a user is determined to be continually changing direction, e.g. while travelling round a curve, then a greater number of determined locations is required to accurately determine the distance travelled.

For the avoidance of doubt, the term “sampling” used herein refers to a selection of data points from a greater population so as to reduce the number of data points. For example, and in preferred embodiments, the sampling can refer to the selection of points at regular intervals, e.g. every 10^{th} point or every 20^{th} point, etc.

In other embodiments, the determined locations, e.g. the locations output from the GNSS receiver, may be sampled according to the determined motion state of the user and an accuracy of the determined locations (e.g. quality of the GNSS signal).

Accordingly, in such embodiments, the mobile device further comprises means for determining the accuracy or “quality” of the determined locations, and which can utilise one or more of: satellite signal strength (e.g. the “relative signal strength indicator” (RSSI)); and expected position errors (e.g. the “expected horizontal position error” (EHPE) and/or the “expected vertical position error” (EVPE)). The means for detecting the accuracy of the detected locations preferably comprises a processing resource, such as one or more (suitably programmed) processors.

Further indications of the quality of the determined locations can be made by comparing data received from the GNSS receiver, such as delta distance and SOG, with corresponding data received from (the) one or more motion sensors in the mobile device and/or (the) one or more external motion sensors, such as a footpad.

In a preferred embodiment, a plurality of different quality states are predefined (e.g. and stored) in the device, and the means is preferably configured to assign the appropriate quality state to each location obtained by the location determining means. For example, the predefined quality states can include: “open sky”—describing a time when the GPS antenna receives a good signal, e.g. when 5 or more satellites can be seen; “limited open sky”—describing a time when the GPS antenna only receives a medium strength signal, e.g. when fewer than 5 satellites can be seen; and “multi-path”—describing a time, such as when the user is travelling through an urban canyon area.

In these embodiments, preferably each combination of motion state or states and quality state has an associated sampling rate (e.g. that is suitable for the type of motion being performed by the user and the accuracy of the locations). The sampling rates can be selected as desired, however, in a preferred embodiment at least some, and preferably all, of the sampling rates are different.

For example, if a user is running on an athletics track, e.g. in a circular motion“, and there is good satellite reception, then the predefined sampling rate might be 1 Hz (i.e. with one location—longitude, latitude pair—being selected every second). Alternatively, if a user is walking slowly in a linear motion, ad there is poor satellite reception, then the predefined sampling rate may be 0.1 Hz (i.e. with location—longitude, latitude pair—being selected every 10 seconds).

The locations that are selected during the sampling process, referred to herein as “critical” locations, are subjected to further processing as discussed in more detail below. The non-selected locations, referred to herein as “non-critical” locations, are removed from further processing. These non-critical locations can be discarded completely, i.e. not stored on the device for future use, or they may be removed from further processing, but still be retained on the device.

Preferably, the critical locations are subjected to a smoothing process, e.g. in which one or more smoothing functions or curves are fitted to the data as appropriate. Therefore, in a preferred embodiment, the mobile device comprises means for applying a smoothing function to the critical locations received from the sampling means. The means for smoothing the critical locations preferably comprises a processing resource, such as one or more suitably programmed processors. As will be appreciated, smoothing the location data, e.g. as received from the GNSS receiver, improves the accuracy of the estimated distance travelled by the user by reducing, and in some cases even negating, the time varying errors associated with location data obtained from GNSS receivers.

Any smoothing process can be used as desired, such as moving average or least square smoothing. In a preferred embodiment, however, a spline smoothing algorithm is used, and most preferably a cubic spline algorithm.

Thus, in a preferred embodiment, a smoothing algorithm is applied to a plurality of consecutive critical points to generate a smooth curve between the points, typically referred to as “control points”, that is indicative of the journey taken by the user. In the case where a cubic spline algorithm is used, four consecutive critical points are used as control points.

This process is repeated for the next series of critical points, e.g. for the next four consecutive critical points, and so on, with a smooth curve being generated in respect of each set of critical points.

For the avoidance of doubt, the generation of a smooth curve can comprise defining a continuous curve or, as is more typical, inserting a plurality of interpolants, e.g. new discrete data points, between two “knots” of the spline, e.g. the first and last control points. The number of interpolants inserted between the knots can be selected as desired to provide an appropriate “resolution” of the smooth curve.

Once the critical points are smoothed, i.e. a smooth function or curve has been generated, the smoothed curve is preferably sampled so as to produce one or more, preferably a plurality, of discrete locations, e.g. as defined by longitude and latitude coordinates, that are indicative of the journey taken by the user.

The smooth curve can be sampled at any suitable and desired rate. For example, the smooth curve can be sampled at a rate of 0.05 Hz to 10 Hz, and preferably between 0.1 and 1 Hz.

The rate may be predefined in the device, e.g. a default sample rate of 1 Hz may be used. In a preferred embodiment, however, the sample rate can be selected by the user. The user can select a rate before starting a journey or workout, for use throughout the entire journey. It is also possible that the user may input different sample rates throughout a single journey. For example, if a user is performing a triathlon, or similar multi-event activity, then different sample rates may be desired for each of the different events. As those skilled in the art will understand, the user will select a sample rate based on, for example, the speed at which they are moving and/or the type of movement that is being performed. In other embodiments, the sample rate may be varied based on the data obtained from the motion state determining means.

As will therefore be appreciated, the present invention preferably uses the locations determined by a GNSS receiver and the determined motion states of the user and/or device to determine a plurality of discrete “adjusted” locations. More specifically, a set of adjusted locations is determined from each generated smooth curve, and a distance determined in respect of each set of adjusted locations. This latter distance is commonly referred to as the “delta distance”. Preferably, the delta distance values represent 2D distances, i.e. the distance travelled at a constant elevation, with the adjusted locations comprising adjusted longitude, latitude pairs.

In the present invention, the distance, preferably the 2D distance, travelled by the user during at least a portion of the journey is estimated by summing the calculated delta distances.

As discussed above, although the system (and preferably mobile device) of the present invention is primarily configured to be carried or worn by a user, it is contemplated that the device can be transported by the user, e.g. by attaching the device to the frame of a bicycle or other type of vehicle. When the mobile device is used in this manner, the dynamics experienced by the device, e.g. forms of movement, changes in direction, speed, etc, can, at least in some situations, be similar to those typically experienced by PNDs.

Accordingly, in a preferred embodiment, the present invention further comprises:

means for determining the speed of the user at a plurality of times during the journey; and

means for determining the distance travelled by the user during at least a portion of the journey using the plurality of the determined speeds.

The speed determining means can any suitable and desired device. However, in a preferred embodiment, the speed determining means comprises a (or the) GNSS receiver for receiving satellite signals indicating the speed at which the receiver is moving over the ground.

For the avoidance of doubt, the “speed” of the user refers, unless the context requires otherwise, to the magnitude of the velocity of the user (e.g. the velocity vector obtained form the GNSS receiver).

As is known in the art, e.g. from vehicle PNDs, the distance travelled by a vehicle can be determined by integrating the speed over ground (SOG) values obtained from a GNSS receiver over time. Thus, in a preferred embodiment of the present invention, the distance travelled by the user during at least a portion of the journey can be calculated by integrating the plurality of determined speeds, e.g. the received SOG values, with respect to time, or more preferably by integrating SOG values derived from the received SOG with respect to time. Any suitable integration techniques can be used as desired, e.g. numerical integration or vector integration.

In the same manner that determined geographic locations of the device are sampled and smoothed to provide adjusted locations, e.g. as described above, preferably the determined speeds of the device can be subjected to similar processing. This allows the accuracy of the determined speeds to be improved, e.g. particularly if the determined speeds are SOG values obtained from a GNSS receiver. For example, as will be understood, conventional techniques available in vehicle navigation, i.e. in PNDs, such as map matching, can not be used with the present invention (because the device does not have access to a digital map in normal use).

Therefore, the step of determining the distance travelled by the user preferably comprises applying a smoothing process to the plurality of determined speed values, e.g. in which one or more “smooth” functions or curves are fitted to the data as appropriate. The speed values that are smoothed may, for example, be those as received from the GNSS receiver. Alternatively, in other embodiments, the received SOG values may first be pre-processed using one or more techniques as known in the art.

The function or functions generated by the smoothing process are preferably sampled at a rate, e.g. as desired and in some embodiments as input by the user, to generate a series of “smoothed” speeds, which can then be used to determine the distance travelled. As will be appreciated, the individual speeds can be, and preferably are, sampled and smoothed using any of the preferred and optional features discussed above in relation to the determined geographic locations, as appropriate. For example, the smoothing process preferably comprises using a spline smoothing algorithm, and most preferably a cubic spline algorithm. Similarly, the generated smooth curves are preferably sampled at a rate of 0.05 Hz to 10 Hz, and preferably between 0.1 and 1 Hz, the rate preferably being selected by a user or alternatively being based on the determined motion state of the user.

Thus, in the present invention, the distance, preferably the 2D distance transmitted by the user during at least a portion of the journey is estimated by summing the calculated integrals of the determined speed values.

In the present invention, it will therefore be seen that it is possible to determine a distance travelled by a user using “delta distance” (i.e. the distance between individual locations) or “speed over ground” (i.e. the integral of the speed with respect to time), and indeed both techniques may, and often will, be used to determine the distance travelled by the user over the course of a journey.

Thus, in a preferred embodiment, the mobile device further comprises means for selectively determining the distance travelled by a user during at least a portion of a journey using one of: (i) the plurality of determined locations and the determined motion states of the user; and (ii) the plurality of determined speeds. The decision to use (select) one or other of the techniques is based on one or more criteria, such as according to the determined motion state of the user and/or the determined accuracy or “quality” of the received GNSS signal. For example, the decision can be based on which predefined motion state or states the user/device is determined to be in and/or the determined quality state, e.g. of the data obtained from the GNSS receiver.

It is believed that the selective use of two or more different ways of determining the distance travelled by a user based on a determined motion state of the user may be new and advantageous in its own right.

Thus, according to a third aspect of the present invention, there is provided a system configured to be transported, carried or worn by a user, comprising:

means for determining the location of the user at a plurality of times during a journey from a first location to a second location;

means for determining the speed of the user at a plurality of times during the journey;

means for determining a motion state of the user at a plurality of times during the journey; and

means for determining the distance travelled by the user during at least a portion of the journey by selectively using the plurality of determined locations or the plurality of determined speeds based on the determined motion states of the user.

According to a fourth aspect of the present invention, there is provided a method of determining the distance travelled by a user during at least a portion of a journey from a first location to a second location using a system configured to be transported, carried or worn by the user, the method comprising;

determining a motion state of the user at a plurality of times during the journey; and

selectively using one of: (i) a plurality of locations of the user during the journey; and (ii) a plurality of speeds of the user during the journey, to determine the distance travelled by the user based on the determined motion states of the user.

In these aspects of the invention, the distance travelled by the user can be calculated using “delta distance” (i.e. summing the distance between individual locations) or “speed over ground” (i.e. summing the integral of the speed between individual locations) based on a determined motion state of the user and/or device. It will be appreciated that the distance may be determined using only one of the “delta distance” and the “speed over ground” techniques. Alternatively, the distance may be determined using a combination of the delta distance and speed over ground techniques, e.g. with the distance associated with one or more portions of the journey being determined using the delta distances and the distance associated with one or more other portions of the journey being determined using the integrals of the speed over ground values.

As will be appreciated by those skilled in the art, these aspects of the invention can, and preferably do, include one or more or all of the preferred and optional features of the invention described herein, as appropriate.

Thus, the distance can be determined using a plurality of determined locations (i.e. the “delta distance” technique) using any of the preferred and optional features discussed above. For example, the determined locations can be sampled and smoothed based on the determined motion state or states of the user and/or device, and the distance determined from the adjusted locations.

Similarly, the distance can be determined using a plurality of determined speeds (i.e. the “speed over ground” technique) using any of the preferred and optional features discussed above. For example, the determined speeds can be pre-processed and/or smoothed and sampled, and the distance determined from the adjusted speeds.

As discussed above, the distance determined using “delta distance” or “speed over ground” preferably comprises a 2D distance. In some embodiments, the distance displayed to user may be this 2D distance. Alternatively, in other embodiments, it is desirable to additionally take account of any changes in elevation made by the user during a journey. Accordingly, in a preferred embodiment of the present invention, data concerning the changes in elevation experienced by the user and/or device during the journey is used together with the determined 2D distance to determine a 3D distance, e.g. using a trigonometric operation.

The changes in elevation experienced by the user and/or device can be determined using any suitable and desired means. For example, the mobile device may comprise a barometric sensor. Preferably, however, the elevation data is obtained from the GNSS receiver. Thus, in a preferred embodiment, for each “distance” that is determined by the device, e.g. the distance determined from sampling the generated smooth curves, an associated change in elevation is determined and used to calculate a 3D distance.

In a preferred embodiments, the locations received from the GNSS receiver comprise longitude, latitude and elevation, and the determined elevation values (or determined changes in elevation) are smoothed and sampled, e.g. as described above in relation to the plurality of determined locations and speeds. Therefore, preferably, a smoothing process is applied to a plurality of determined elevation values, e.g. in which one or more “smooth” functions or curves are fitted to the data as appropriate. The elevation values that are smoothed may, for example, be those as received from the GNSS receiver. Alternatively, in other embodiments, the received elevation values may first be pre-processed using one or more techniques as known in the art. As will be appreciated, the individual elevation values can be, and preferably are, sampled and smoothed using any of the preferred and optional features discussed above. For example, the smoothing process preferably comprises using a spline smoothing algorithm, and most preferably a cubic spline algorithm. Alternatively, other statistical techniques as known in the art can be used, such as a moving average. Such smoothing techniques compensate for the noise often found in elevation values received from GNSS receivers.

Preferably, the sampled elevation values (or changes in elevation) are analysed to determine if there is a “net” positive or negative change in elevation. If such a change is determined, then the 2D distance for the corresponding portion of the journey is converted into a 3D distance as appropriate.

As will be appreciated, in the preferred embodiments of the invention wherein the location determining means comprises a GNSS receiver, there can be situations, such as when a user is moving within an dense urban environment, when no satellite signals can be received or the accuracy of the received can no longer be relied on.

Accordingly, the mobile device preferably comprises one or more sensors capable of determining the distance travelled by a user when GPS data is not available for use. Such sensors are often referred to as “dead reckoning” sensors. Any suitable form of sensor can be used for this purpose, such as: a sensor to provide a heading of the user and/or device (e.g. a compass); and/or a sensor arranged to function as a pedometer, and which may be, for example, an accelerometer in the mobile device or a foot pad sensor (e.g. accelerometer). Preferably, the data obtained from the pedometer will be calibrated for the user of the mobile device, and may, for example, be calibrated based on previously obtained data from the GNSS receiver.

It will therefore be understood that the distance travelled by a user during a journey from a first location to a second location may be calculated using one or more or all of the following techniques: “delta distance”; “speed over ground”; and “dead reckoning”. It is believed that using one of other of locations and speeds obtained by a GNSS receiver, together with a pedometer calibrated using data obtained from the GNSS receiver, to determine the distance travelled by a user may be new and advantageous in its own right.

Thus, according to a fifth aspect of the present invention, there is provided a system configured to be transported, carried or worn by a user, comprising:

a global navigation satellite system (GNSS) receiver arranged to obtain the location and/or speed of the user;

a pedometer for counting steps made by the user;

means for determining the distance travelled by the user during a first time period using locations and/or speeds obtained by the GNSS receiver, wherein during the first time period signals obtained by the GNSS receiver meet one or more accuracy and/or reliability criteria;

means for calculating a calibrated distance per step associated with the first time period using the determined distance travelled during the first time period and the counted number of steps made during the first time period; and

means for determining the distance travelled by the user during a second time period using the counted number of steps made during the second time period and the calibrated distance per step associated with the first time period, wherein during the second time period signals obtained by the GNSS receiver do not meet said one or more accuracy and/or reliability criteria;

said system further comprising:

means for re-calculating the calibrated distance per step each time the user is determined to travel a distance greater than a predefined distance value during a period of time in which signals obtained by the GNSS receiver meet the one or more accuracy and/or reliability criteria.

According to a sixth aspect of the present invention, there is provided a method of determining a distance travelled by a user using a system transported, carried or worn by the user, the system comprising: a global navigation satellite system (GNSS) receiver arranged to obtain the location and/or speed of the user; and a pedometer for counting steps made by the user, the method comprising:

determining the distance travelled by the user during a first time period using locations and/or speeds obtained by the GNSS receiver, wherein during the first time period signals obtained by the GNSS receiver meet one or more accuracy and/or reliability criteria;

calculating a calibrated distance per step associated with the first time period using the determined distance travelled during the first time period and the counted number of steps made during the first time period; and

determining the distance travelled by the user during a second time period using the counted number of steps made during the second time period and the calibrated distance per step associated with the first time period, wherein during the second time period signals obtained by the GNSS receiver do not meet said one or more accuracy and/or reliability criteria;

the method further comprising:

re-calculating the calibrated distance per step each time the user is determined to travel a distance greater than a predefined distance value during a period of time in which signals obtained by the GNSS receiver meet the one or more accuracy and/or reliability criteria.

In these aspects of the invention, data obtained by a GNSS receiver, e.g. a GPS receiver, is used to continuously calibrate a pedometer when the location and/or speed information acquired by the GNSS receiver can be trusted. Then, subsequently, when the user travels through an area where the information obtained from the GNSS receiver can no longer be relied upon (e.g. areas where GPS reception is poor or simply not available), the distance travelled by the user is determined using the calibrated pedometer until the information from the GNSS receiver can again be trusted.

As will be appreciated by those skilled in the art, these aspects of the invention can, and preferably do, include one or more or all of the preferred and optional features of the invention described herein, as appropriate. For example, the distance travelled during the first time period can be calculated using locations (i.e. delta distance) or speeds (i.e. speed over ground) obtained from the GNSS receiver, or a combination of the two, as appropriate.

The distance can be determined using a plurality of determined locations (i.e. the “delta distance” technique) using any of the preferred and optional features discussed above. For example, the determined locations can be sampled and smoothed based on the determined motion state or states of the user and/or device, and the distance determined from the adjusted locations.

Similarly, the distance can be determined using a plurality of determined speeds (i.e. the “speed over ground” technique) using any of the preferred and optional features discussed above. For example, the determined speeds can be pre-processed and/or smoothed and sampled, and the distance determined from the adjusted speeds.

The one or more accuracy and/or reliability criteria associated with the GNSS receiver provide an indication when the satellite signals can no longer be received or can no longer be relied upon. The criteria can therefore include satellite availability, satellite signal strength, estimated (horizontal or vertical) position errors, etc.

The calibrated distance per step is re-calculated each time the user is determined to travel a distance greater than a predefined distance value during a period of time in which signals obtained by the GNSS receiver meet the one or more accuracy and/or reliability criteria. This therefore ensures that the calibrated distance per step reflects, as much as possible, the latest dynamical motion of the user. The predefined distance value can be chosen as desired, but in a preferred embodiment is 200-2000 metres, most preferably 500 metres.

The system preferably comprises data storage means for storing the calibrated distance per step, once calculated, such that it can be used when required at a later time. Thus preferably, the method of the present invention comprises storing the calibrated distance per step, and furthermore preferably replacing the stored value with a new value whenever a new calibrated distance per step is calculated.

The pedometer can comprise any suitable device as desired. For example, the pedometer can comprise a foot pad sensor, such as a piezoelectric accelerometer, that is preferably positioned in a shoe worn by the user. The pedometer could, additionally or alternatively, comprise an accelerometer, e.g. as described above and contained within a housing of the mobile device, and which therefore functions in a dual role as a motion state detector (for use in “delta distance” determinations) and as a pedometer. In those embodiments, wherein the system comprises both a foot pad sensor and an accelerometer, then typically the foot pad sensor would be used as the pedometer (although alternatively a determination as to the accuracy of the two devices could be made, and the most accurate at a particular point time used as the pedometer).

As discussed above, the pedometer and (stored) calibrated distance per step (or in other words “GNSS-calibrated pedometer”) is used to determine the distance travelled by the user during a second time period when signals obtained by the GNSS receiver do not meet the necessary accuracy and/or reliability criteria. According, the GNSS-calibrated pedometer is used in place of the GNSS receiver whenever: there is a GPS outage; a (least-squares) position fix cannot be established, e.g. when signals can not be received from at least four satellites; or the signal strength from the fourth satellite is less than a predetermined threshold. The predetermined threshold can be selected as desired, but preferably is a value between 20 and 30 dB-Hz, most preferably 26 dB-Hz.

In a preferred embodiment, however, it is also contemplated that the GNSS-calibrated receiver can be used in place of the GNSS receiver during a time period when the accuracy and/or reliability criteria are fulfilled, but have not yet been fulfilled for a predetermined period of time. The period of time can be 2-10 seconds, more preferably 2-5 seconds, and most preferably 3 seconds.

Thus, preferably, the method further comprises determining the distance travelled by the user during a third time period using the counted number of steps made during the third time period and the calibrated distance per step associated with the first time period, wherein during the third time period signals obtained by the GNSS receiver have not met said one or more accuracy and/or reliability criteria for a predetermined period of time.

(It will be appreciated that it is possible for there to be reduced GPS quality at the start of a journey, and before it has been possible to calibrate the pedometer. It such situations, data obtained from the GNSS receiver can be used instead of the pedometer despite the fact that the accuracy of the GNSS data cannot be trusted.)

As discussed above, the system comprises a portable personal training device. In a particularly preferred embodiment, the system comprises a mobile device having a housing containing at least a portion, and preferably all, of the location determining means and the means for determining a motion state of the user and/or device. Preferably, if the system comprises one or more external sensors, then the means for communicating with such external sensors is also, at least partially, within the housing.

As discussed above, the mobile device can be configured so as to be carried or transported by a user. In a preferred embodiment, however, the housing of the mobile device comprises a strap for securing the housing to a user. The strap, for example, can be arranged to secure the housing to the user's wrist in the manner of a watch. In other words, the mobile device is preferably a sports watch.

The mobile device preferably comprises a display for providing information to the user, such as information as obtained or derived from the location determining means, e.g. distance travelled, current speed, average speed, elevation, etc. The display screen can include any type of display screen, such as an LCD display, e.g. that can display both text and graphical information.

The mobile device preferably comprises one or more input means to allow the user to select one or more functions of the device and/or to input information to the device, such as to display particular information on the display. The input means can comprise one or more buttons, switches or the like attached to the housing, a touch panel and/or any other suitable device. For example, the housing could be arranged to be touch sensitive such that the user can input information, request a change in the information being displayed, etc by touching appropriate portions of the housing. The input means and the display could be integrated into an integrated input and display device, including a touchpad or touchscreen input so that a user need only touch a portion of the display to select one of a plurality of display choices or to activate a virtual button or buttons. The input means may additionally or alternatively comprise a microphone and software for receiving input voice commands as well.

The mobile device may include an audible output device, such as a loudspeaker, for providing audible information, such as instructions, alerts, etc, to a user. For example, the output device can provide an indication when a target distance has been travelled and/or when a target speed has been achieved.

In a preferred embodiment of the present invention, the mobile device comprises data storage means, e.g. for storing one or more locations received from the location determining means. The data storage means can comprise memory, such as volatile or non-volatile memory, which may be integral with the location determining means. Alternatively, the data storage means can be removable.

Preferably, at least some of the data received from the location determining means and/or any of the movement sensors contained within or accessible by the mobile device can be stored on the data storage means. The data may be stored in the form as received, but in a preferred embodiment, the received data is first modified before being stored. For example, in a preferred embodiment, at least some, and preferably all, of the adjusted locations, e.g. those sampled from the smoothed curves, may be stored on the data storage means (e.g. instead of the locations actually received from the GNSS receiver). Similarly, in a preferred embodiment, data from the accelerometer(s) may be stored on the data storage means. The data may be stored on the device in any suitable and desired format, e.g. in a compressed format.

The data stored on the data storage means of the mobile device can be arranged to be transferred to a central server, e.g. whereupon it is used to determine the route travelled by the user during the journey with respect to a digital map. The data on the mobile device can be transferred to the central server using any suitable and desired means. For example, the mobile device could be provided with wireless communication means to allow data stored on the data storage means to be transferred over the air, for example, to a computer or other device that has access to the Internet. Alternatively, and in a preferred embodiment, the mobile device comprises a data connector, such as a USB connector, that is connected to at least the data storage means. Data on the data storage means can therefore be transferred to a computer or other suitable device by inserting the connector into a suitable port.

In those embodiments in which the mobile device is a sports watch, the data connector is preferably provided at one end of the strap of the watch. The sports watch preferably comprises a protective cover that can be selectively opened or closed by the user. When in the “closed” position, the protective cover is positioned over the data connector, and preferably held in place by suitable releasable locking means, thereby protecting the data connector from damage when the watch is in use. When in the “open” position, the data connector is exposed and can be inserted into a complementary port of a computer or other suitable device.

As will be appreciated, the mobile device will comprise a power source, e.g. for providing power to the various components and sensors of the device. The power source can take any suitable form, although in a preferred embodiment, the power source comprises a rechargeable battery, e.g. that can be recharged when the aforementioned data connector is inserted into a port on a computer or other suitable device. In other words, the data connector preferably comprises a power and data connector.

As will be appreciated by those skilled in the art, all of the aspects and embodiments of the invention described herein can and preferably do include any one or more of the preferred and optional features of the invention described herein, as appropriate.

The methods in accordance with the present invention may be implemented at least partially using software, e.g. computer programs. The present invention thus also extends to a computer program comprising computer readable instructions executable to perform a method according to any of the aspects or embodiments of the invention.

The invention thus also extends to a computer software carrier comprising software which when used to operate a system or apparatus comprising data processing means causes, in conjunction with said data processing means, said apparatus or system to carry out the steps of the methods of the present invention. Such a computer software carrier could be a non-transitory physical storage medium, such as a ROM chip, CD ROM or disk, or could be a signal, such as an electronic signal over wires, an optical signal or a radio signal such as to a satellite or the like.

As will be appreciated, the present invention encompasses a number of new and advantageous aspects. For example, according to an aspect, the distance travelled update rate can be maintained at a typical vehicle application rate, e.g. 1 Hz, but can be adapted as desired based on user preference. According to another aspect, the (2D) distance is derived from either delta distance of current and previous position fix data or numerical integration of ground speed both with proper filtering/smoothing. According to another aspect, the (2D) distance can still be derived during GNSS signal outage using a step length derived from an accelerometer. According to another aspect, cubic spline smoothing is applied, together with adaptive down sampling, to position data obtained from a GNSS receiver to filter out the position jump/drift due to multi-path and/or other noise sources. The down sampling rate can be selected based on user motion state flag and measurement quality indication flags. The user motion indication flag may be derived by a joint decision from 3-axis accelerometer, estimated horizontal position error (EHPE), delta distance and ground speed. The measurement quality indication flag may be derived from a joint decision from step length, estimated horizontal position error (EHPE), estimated vertical position error (EVPE), delta distance, ground speed and signal strength.

Where not explicitly stated, it will be appreciated that the invention in any of its aspects may include any or all of the features described in respect of other aspects or embodiments of the invention to the extent that they are not mutually exclusive. In particular, while various embodiments of operations have been described which may be performed in the method and by systems or apparatus, it will be appreciated that any one or more or all of these operations may be performed in the method and by the system or apparatus, in any combination, as desired, and as appropriate.

Advantages of these embodiments are set out hereafter, and further details and features of each of these embodiments are defined in the accompanying dependent claims and elsewhere in the following detailed description.

### BRIEF DESCRIPTION OF THE DRAWINGS

Various aspects of the teachings of the present invention, and arrangements embodying those teachings, will hereafter be described by way of illustrative example with reference to the accompanying drawings, in which:

FIG. 1 is a schematic illustration of a Global Positioning System (GPS);

FIG. 2 is a schematic illustration of electronic components arranged to provide a portable personal training device;

FIG. 3 shows an embodiment of the device of FIG. 2, wherein the device is in the form of a sports watch;

FIG. 4 is a schematic illustration of the manner in which a navigation device may receive information over a wireless communication channel;

FIG. 5 shows the system architecture associated with the device of FIG. 2 when acting as a GPS odometer;

FIG. 6 shows the manner by which the “user motion state indication” flag is set;

FIG. 7 shows the manner by which the “measurement quality indication flag” is set;

FIG. 8 shows an exemplary pre-down sampling process;

FIG. 9 shows an exemplary cubic spline smoothing algorithm associated with the GPS locations;

FIG. 10 shows an exemplary post-down sampling process;

FIG. 11 shows an exemplary cubic spline smoothing algorithm associated with the speeds obtained by a GPS receiver;

FIG. 12 shows an exemplary process by which the 3D distance to be output from the GPS odometer can be calculated;

FIG. 13 shows an exemplary cubic spline smoothing algorithm associated with the elevations obtained by a GPS receiver;

FIG. 14 shows the system architecture associated with the device of FIG. 2 when acting as an odometer using inputs from a GPS odometer and a pedometer odometer;

FIG. 15 shows an exemplary process for selecting whether to use the GPS odometer or pedometer odometer as an input; and

FIG. 16 shows an exemplary calibration process associated with the pedometer odometer.

Like reference numerals are used for the like features throughout the drawings.

### DETAILED DESCRIPTION OF THE PREFERRED EMBODIMENTS

Preferred embodiments of the present invention will now be described with particular reference to a portable personal training device, such as a sports watch, having access to Global Positioning System (GPS) data. Sports watches after the type described are often worn by athletes to help them during their runs or workouts, e.g. by monitoring the speed and distance of the user and providing this information to the user. It will be appreciated, however, that the device could be arranged to be carried by a user or connected or “docked” in a known manner to a vehicle such as a bicycle, kayak, or the like.

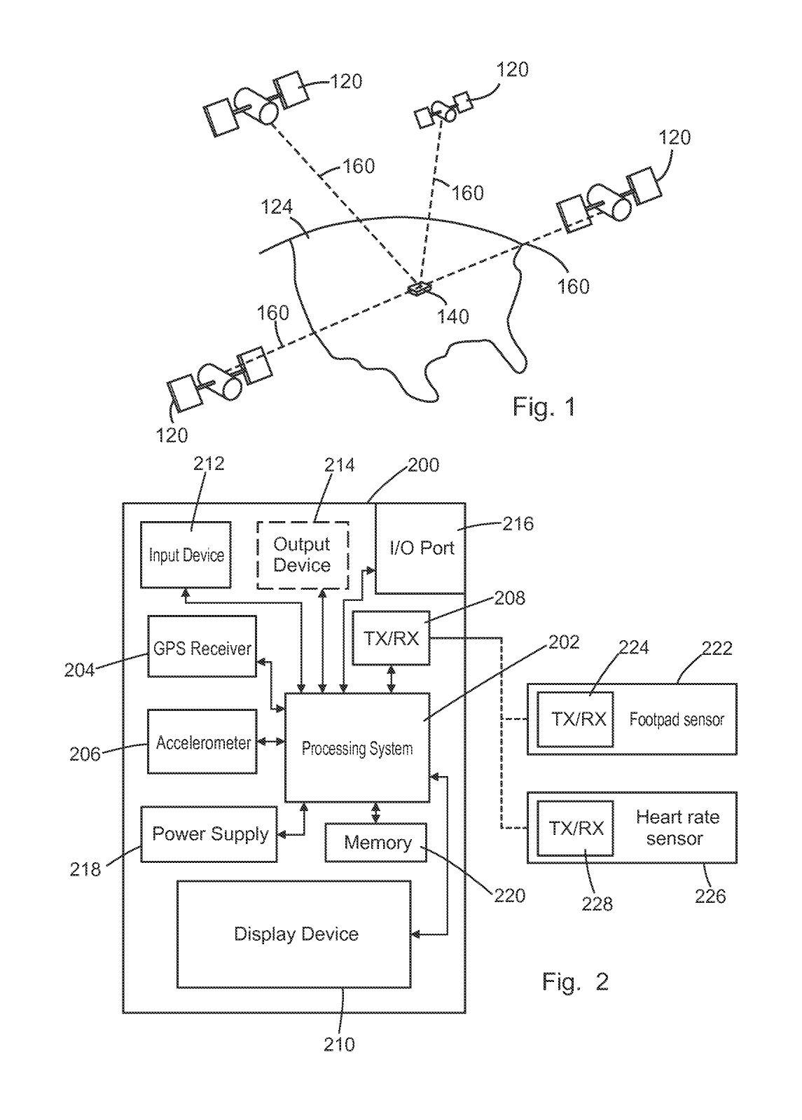

FIG. 1 illustrates an example view of Global Positioning System (GPS), usable by such devices. Such systems are known and are used for a variety of purposes. In general, GPS is a satellite-radio based navigation system capable of determining continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal will allow the receiving device to calculate its three dimensional position by the same geometrical calculation in a known manner. The position and velocity data can be updated in real time on a continuous basis by an unlimited number of users.

As shown in FIG. 1, the GPS system is denoted generally by reference numeral 100. A plurality of satellites 120 are in orbit about the earth 124. The orbit of each satellite 120 is not necessarily synchronous with the orbits of other satellites 120 and, in fact, is likely asynchronous. A GPS receiver 140 is shown receiving spread spectrum GPS satellite signals 160 from the various satellites 120.

The spread spectrum signals 160, continuously transmitted from each satellite 120, utilize a highly accurate frequency standard accomplished with an extremely accurate atomic clock. Each satellite 120, as part of its data signal transmission 160, transmits a data stream indicative of that particular satellite 120. It is appreciated by those skilled in the relevant art that the GPS receiver device 140 generally acquires spread spectrum GPS satellite signals 160 from at least three satellites 120 for the GPS receiver device 140 to calculate its two-dimensional position by triangulation. Acquisition of an additional signal, resulting in signals 160 from a total of four satellites 120, permits the GPS receiver device 140 to calculate its three-dimensional position in a known manner.

FIG. 2 is an illustrative representation of electronic components of a personal portable training device 200 according to a preferred embodiment of the present invention, in block component format. It should be noted that the block diagram of the device 200 is not inclusive of all components of the navigation device, but is only representative of many example components.

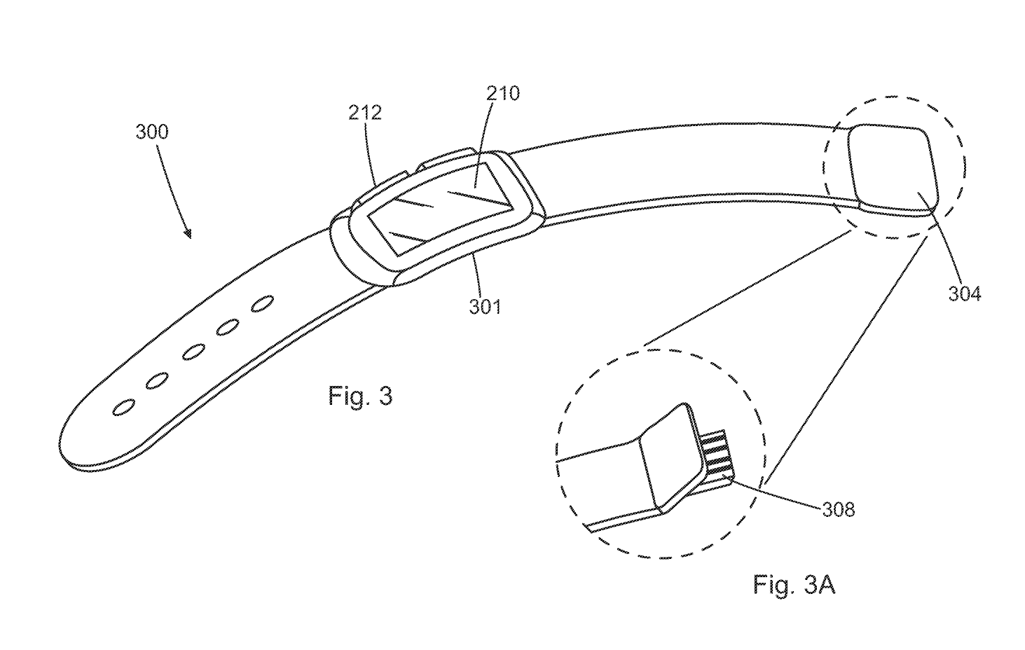

The device 200 includes a processor 202 connected to an input device 212 and a display screen 210, such as an LCD display. The input device 212 can include one or more buttons or switches (e.g. as shown in FIG. 3). The device 200 can further include an output device arranged to provide audible information to a user, such as alerts that a certain speed has been reached or a certain distance has been travelled.

FIG. 2 further illustrates an operative connection between the processor 202 and a GPS antenna/receiver 204. Although the antenna and receiver are combined schematically for illustration, the antenna and receiver may be separately located components. The antenna may be a GPS patch antenna or helical antenna for example.

The device 200 further includes an accelerometer 206, which can be a 3-axis accelerometer arranged to detect accelerations of the user in x, y and z directions. As will be explained in more detail below, the accelerometer may play a dual role: firstly as a means for determining a motion state of the wearer at a particular moment in time, and secondly as a pedometer for use when/if there is a loss of GPS reception. Although the accelerometer is shown to be located within the device, the accelerometer may also be a external sensor worn or carried by the user, and which transmits data to the device 200 via the transmitter/receiver 208.

The device may also receive data from other sensors, such as a footpad sensor 222 or a heart rate sensor 226. The footpad sensor may, for example, be a piezoelectric accelerometer that is located in or on the sole of the user's shoe. Each external sensor is provided with a transmitter and receiver, 224 and 228 respectively, which can be used to send or receiver data to the device 200 via the transmitter/receiver 208.

The processor 202 is operatively coupled to a memory 220. The memory resource 220 may comprise, for example, a volatile memory, such as a Random Access Memory (RAM), and/or a non-volatile memory, for example a digital memory, such as a flash memory. The memory resource 220 may be removable. As discussed in more detail below, the memory resource 220 is also operatively coupled to the GPS receiver 204, the accelerometer 206 and the transmitter/receiver 208 for storing data obtained from these sensors and devices.

Further, it will be understood by one of ordinary skill in the art that the electronic components shown in FIG. 2 are powered by a power source 218 in a conventional manner. The power source 218 may be a rechargeable battery.

The device 200 further includes an input/output (I/O) device 216, such as a USB connector. The I/O device 216 is operatively coupled to the processor, and also at least to the memory 220 and power supply 218. The I/O device 216 is used, for example, to:

update firmware of processor 220, sensors, etc; transfer data stored on the memory 220 to an external computing resource, such as a personal computer or a remote server; and recharge the power supply 218 of the device 200. Data could, in other embodiments, also be sent or received by the device 200 over the air using any suitable mobile telecommunication means.

As will be understood by one of ordinary skill in the art, different configurations of the components shown in FIG. 2 are considered to be within the scope of the present application. For example, the components shown in FIG. 2 may be in communication with one another via wired and/or wireless connections and the like.

FIG. 3 illustrates a preferred embodiment of the device 200, wherein the device 200 is provided in the form of a watch 300. The watch 300 has a housing 301 in which is contained the various electronic components on the device as discussed above. Two buttons 212 are provided on the side of the housing 301 to allow the user to input data to the device, e.g. to navigation a menu structure shown on the display 210. Any number of buttons, or other types of input means, can alternatively be used as desired.

The watch 300 has a strap 302 for securing the device to a user's wrist. As can be seen the end of the strap 302 has a hinged cover 304 that can be lifted up, e.g. as shown in FIG. 3A, to reveal a USB connector 308. The connector can be inserted into any suitable USB port for power and/or data transfer as described above.

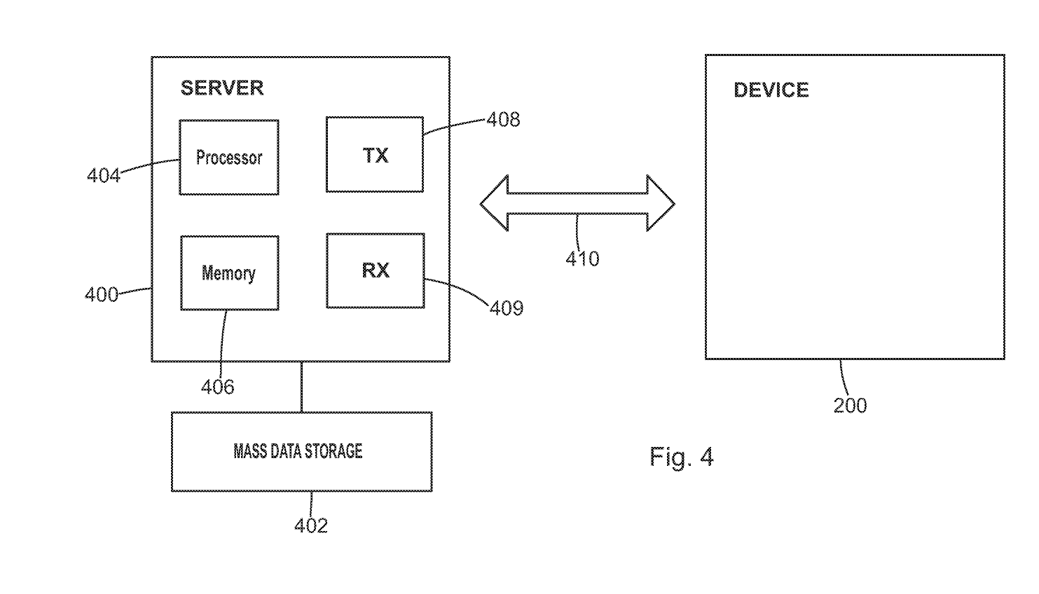

In FIG. 4 the device 200 is depicted as being in communication with a server 400 via a generic communications channel 410 that can be implemented by any number of different arrangements. The server 400 and device 200 can communicate when a connection is established between the server 400 and the navigation device 200 (noting that such a connection can be a data connection via mobile device, a direct connection via personal computer via the internet, etc.).

The server 400 includes, in addition to other components which may not be illustrated, a processor 404 operatively connected to a memory 406 and further operatively connected, via a wired or wireless connection, to a mass data storage device 402. The processor 404 is further operatively connected to transmitter 408 and receiver 409, to transmit and send information to and from device 200 via communications channel 410. The signals sent and received may include data, communication, and/or other propagated signals. The functions of transmitter 408 and receiver 409 may be combined into a signal transceiver.

The communication channel 410 is not limited to a particular communication technology. Additionally, the communication channel 410 is not limited to a single communication technology; that is, the channel 410 may include several communication links that use a variety of technology. For example, the communication channel 410 can be adapted to provide a path for electrical, optical, and/or electromagnetic communications, etc. As such, the communication channel 410 includes, but is not limited to, one or a combination of the following: electric circuits, electrical conductors such as wires and coaxial cables, fibre optic cables, converters, radio-frequency (RF) waves, the atmosphere, empty space, etc. Furthermore, the communication channel 410 can include intermediate devices such as routers, repeaters, buffers, transmitters, and receivers, for example.

In one illustrative arrangement, the communication channel 410 includes telephone and computer networks. Furthermore, the communication channel 410 may be capable of accommodating wireless communication such as radio frequency, microwave frequency, infrared communication, etc. Additionally, the communication channel 410 can accommodate satellite communication.

The server 400 may be a remote server accessible by the device 200 via a wireless channel. The server 400 may include a network server located on a local area network (LAN), wide area network (WAN), virtual private network (VPN), etc.

The server 400 may include a personal computer such as a desktop or laptop computer, and the communication channel 410 may be a cable connected between the personal computer and the device 200. Alternatively, a personal computer may be connected between the device 200 and the server 400 to establish an internet connection between the server 400 and the device 200. Alternatively, a mobile telephone or other handheld device may establish a wireless connection to the internet, for connecting the device 200 to the server 400 via the internet.

The server 400 is further connected to (or includes) a mass storage device 402. The mass storage device 402 contains a store of at least digital map information. This digital map information can be used, together with data from the device, such as time-stamped location data obtained form the GPS receiver 204 and data indicative of motion of the wearer obtained from the accelerometer 206, footpad sensor 222, etc, to determine a route travelled by the wearer of the device 200, which can then be viewed by the wearer.

As will be appreciated, the device 200 is designed to be worn by a runner or other athlete as they undertake a run or other similar type of workout. The various sensors within the device 200, such as the GPS receiver 204 and the accelerometer 206, collect data associated with this run, such as the distance travelled, current speed, etc, and display this data to the wearer using the display screen 210.

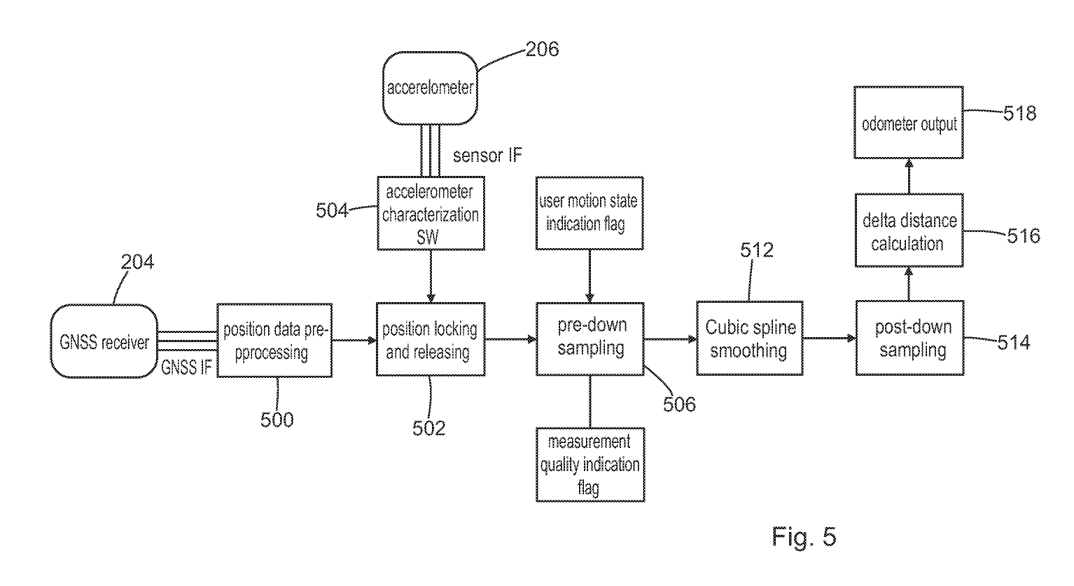

FIG. 5 is a depiction of the process used in the device 200 to determine the distance travelled by the wearer.

As can be seen, the GPS receiver 204 receives satellite signals, when such signals can be received, indicating numerous pieces of information associated with the wearer. For example, the current location of the wearer (longitude and latitude), velocity vector of the wearer, the current elevation of the wearer, etc, together with other data indicative of the “quality” of the satellite signals, such as the estimated horizontal and vertical position error. This information will typically be received at a rate normally associated with vehicle applications, such as 1 Hz. The signals are passed to the processor 202 through an interface. The signal may be pre-processed, e.g. to convert the signals into useable data as known in the art (step 500).

Similarly, the accelerometer 206 is simultaneously obtaining data concerning the dynamical movement of the user and/or device. This data will typically comprise a measure of the acceleration along each of three perpendicular axes, e.g. x, y and z axes. The data from the accelerometer 206 passes though an interface and is then characterised (step 504) to convert the data to identify which of a plurality of motion states the user is in. These motion states are predefined are can include: “standstill”—when the wearer is stationary; “walking”—when the wearer is moving at walking pace; “running”—when the wearer is moving at a running pace; “linear”—when the user is moving in linear fashion; and “circular”—when the user is moving in a circular fashion, such as on a running track. If it is not possible, for whatever reason, to identify the motion state of the wearer, then the user is said to be an “unknown” motion state. Any number of other motion states can be predefined as desired. The wearer may also be seen to be two or more of the predefined states at any one time, e.g. “running” and “circular”. Once the motion state or states of the user have been identified, then a “user motion state indication” flag is set for latter use.

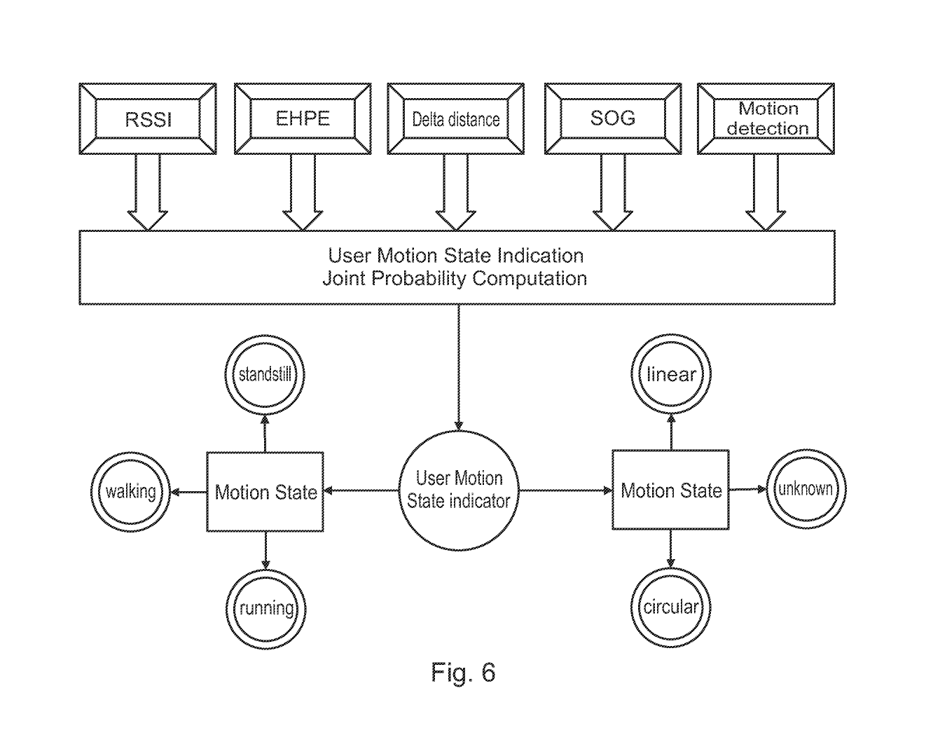

The characterisation of the accelerometer data (i.e. step 504) is shown in detail in FIG. 6. As is depicted, the characterisation is made using the accelerometer data and data obtained from the GPS receiver 204, such as the satellite signal strength (RSSI), estimated position error (EHPE), delta distance and speed over ground (SOG).

As will be discussed in more detail below, the identified motion state or states of the user are used when determining the distance travelled by the wearer (as part of the odometer calculation). In addition, however, if the wearer is identified to be in a “standstill” state, then the location data from the GPS receiver 204 is modified according to a position locking and releasing mechanism (step 502). This mechanism uses the accelerometer to account for the inherent errors associated with GPS locations, wherein even when a device is stationary the received satellite signals may indicate that the device is moving (or “jerking”). Thus, when the wearer is identified as being in a “standstill” state, then the location of the wearer is locked to the last received GPS location, and the location only updated when the wearer begins to move again (i.e. when he or she is no longer seen to be in a “standstill” state).

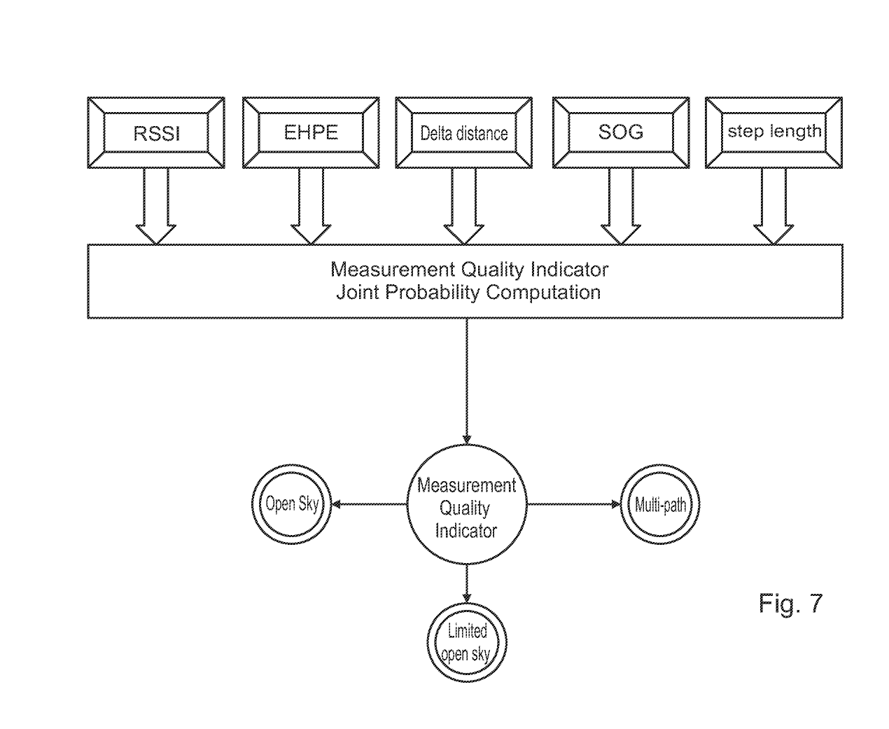

At the same time as the “user motion state indication” flag is set, a “measurement quality indication” flag is also set. This latter flag provides an indication as to the quality or accuracy of the locations received from the GPS receiver 204 (step 500). This is depicted in detail in FIG. 7.

As can be seen from FIG. 7, this determination is made using aspects of the signals received from the GPS receiver 204, such as satellite signal strength (RSSI), estimated position errors (EHPE), and by comparing information from the various other sensors of the device 200. For example, the distance determined using the locations obtained from the GPS receiver 204 (i.e. the delta distance) can be compared to the distance obtained by integrating the speed over ground (SOG), also obtained by the GPS receiver 204, and a distance obtained using a pedometer (such as the accelerometer 206 or footpad sensor 222). Using all these pieces of data, one of number of predefined accuracy or “quality” states can be assigned to the GPS locations, such as “open sky”—when the GPS antenna receives a good signal; “limited open sky”—when the GPS antenna receives a medium strength signal (fewer than five satellites can be seen); and “multi-path”—when the wearer is travelling through an urban canyon environment.

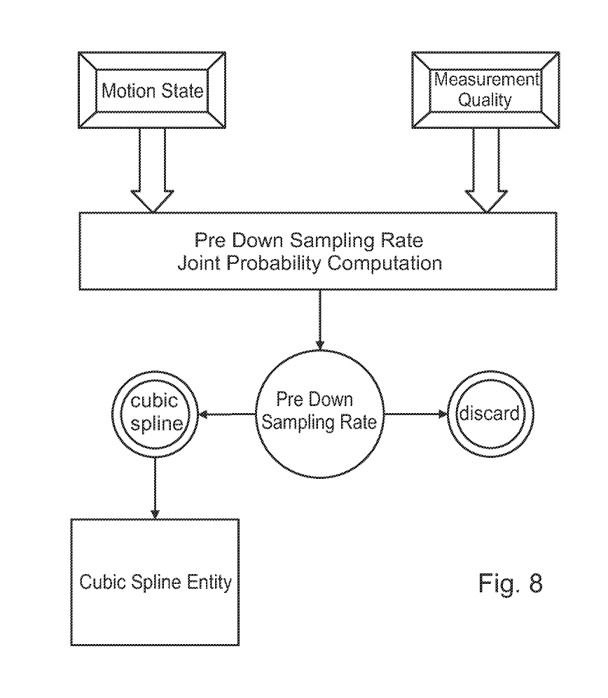

The GPS locations (longitude and latitude) are then processed in a pre-down sampling process (step 506). In this step, the GPS locations are sampled at a rate determined from the “user motion state indication” and “measurement quality indication” flags, and the sampled locations are said to be “critical” locations. The other locations are said to be “non-critical” locations and are discarded. The sampling can involve, for example, every 5^{th} point being selected or every 10^{th} point being selected as desired, and as indicated by the two flags. This process is depicted in FIG. 8.

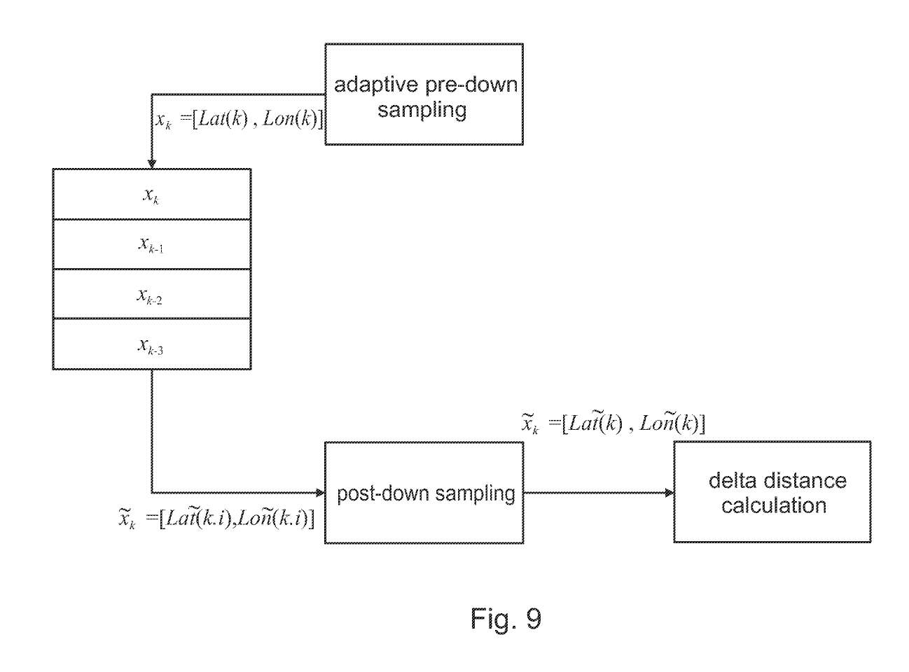

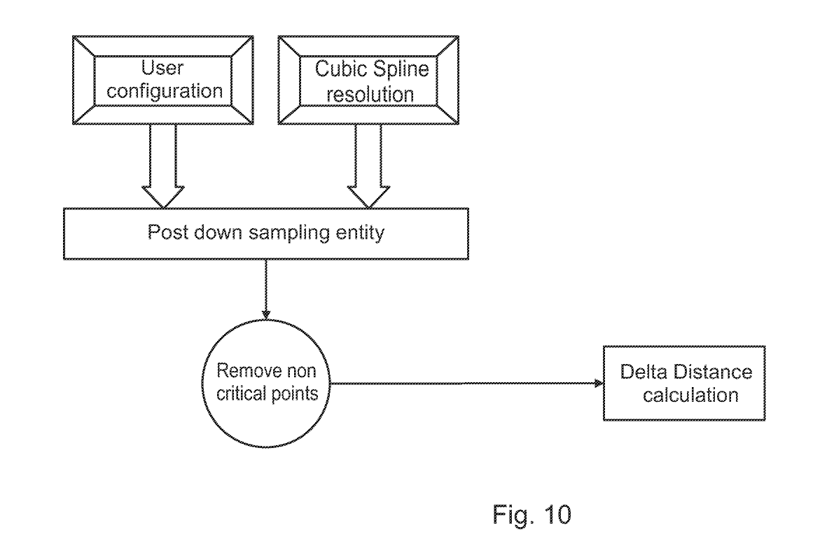

The critical locations are passed to a cubic spline stack for smoothing (step 512). This is depicted in FIG. 9. In this process, a cubic spline is generated in respect of four consecutive critical locations xₖ , xₖ₋₁, xₖ₋₂, xₖ₋₃ as known in the art, thereby generating new adjusted locations \tilde{x}ₖ. As the cubic spline function generates a plurality of interpolants, it is often necessary to remove some of these interpolants to keep the location update rate at a desired level. This is performed in a post-down sampling process (step 514), and which is depicted in FIG. 10. The sampling rate associated with this post-down sampling can be a default rate or the rate can be set by the user (e.g. 1 Hz, 0.5 Hz, etc) and be based on the resolution of the cubic spline. Accordingly, the wearer is given the ability to configure their preferred location update rate. The post down sampling therefore generates a plurality of adjusted locations that can be used in the delta distance calculation, which is discussed in more detail below.

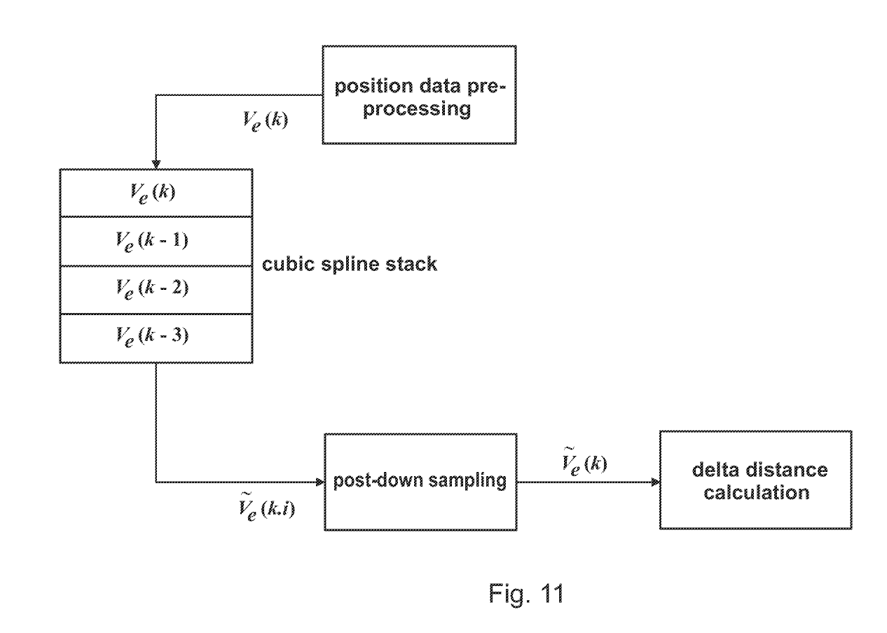

As will be appreciated by those skilled in the art, the distance travelled by the wearer can be determined directly from the GPS locations, i.e. delta distance, but it can also be determined by integrating the speed over ground values, which are also obtained from the GPS receiver 204. Either numerical or vector integration can be used as desired. The speed over ground values can be smoothed using a cubic spline algorithm and subjected to a post-down sampling step in a similar manner to that described above in relation to the GPS locations. This is depicted in FIG. 11.

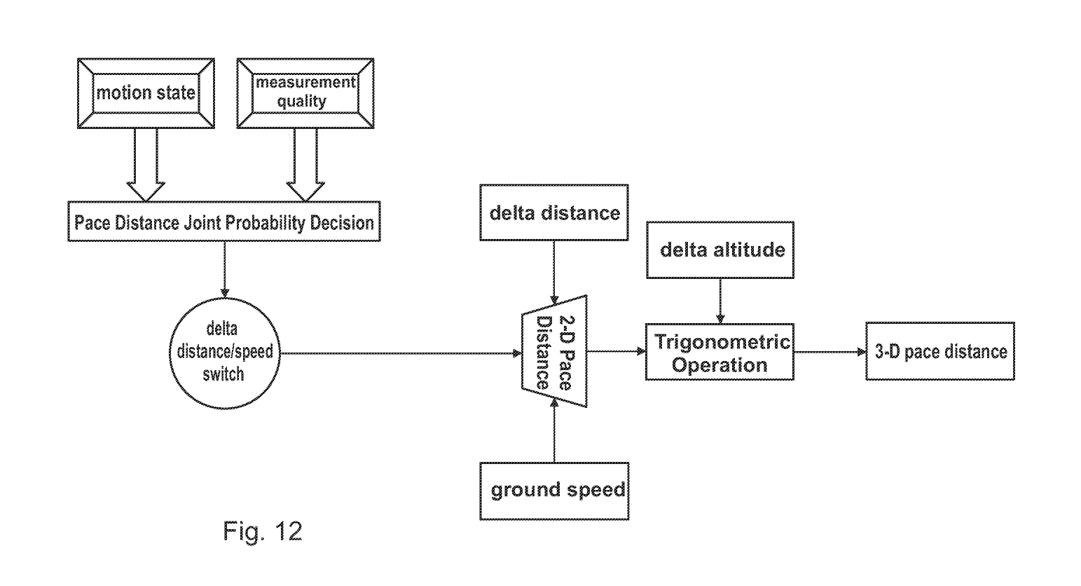

Accordingly, and as is depicted in FIG. 12, a decision can be made again based on the “user motion state indication” and “measurement quality indication” flags to select whether to determine the distance travelled by the user using delta distance (i.e. the distance indicated by the difference in longitude and latitude between two adjacent locations) or speed over ground for each portion of the journey. Based on this decision, a 2D distance that has been travelled by the user can be determined. In some cases, the 2D distance will be sufficient, for example, if the wearer is travelled over relatively flat terrain. If required, however, the 2D distance can be converted into a 3D distance by taking account of changes in elevation experienced by the user. The 3D distance is calculated using a trigonometric operation as known in the art.

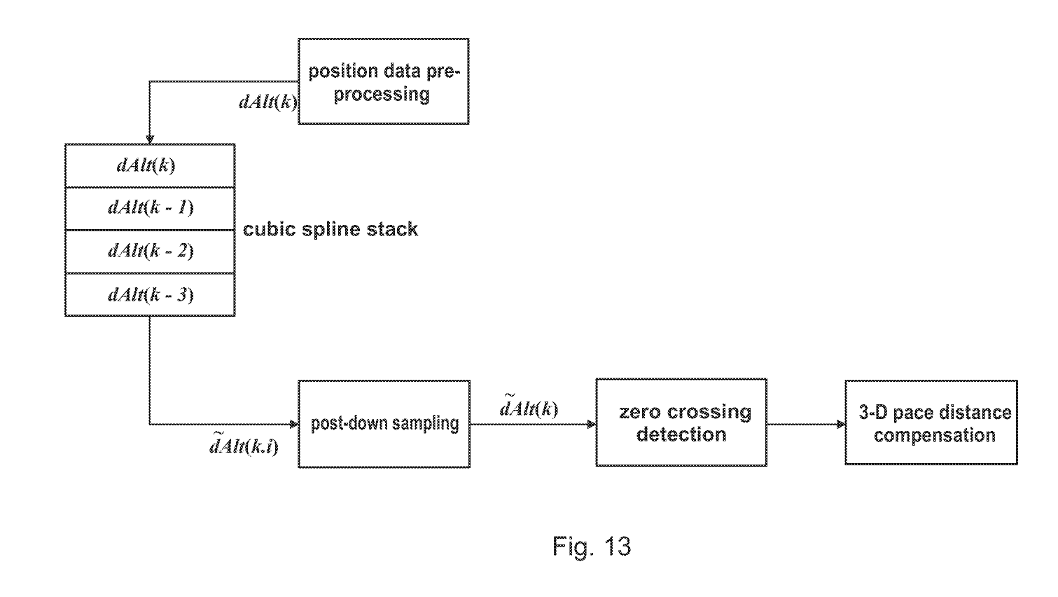

The elevation of the user is again provided by the GPS receiver 204, when there are a sufficient number of satellites. The elevation values can be smoothed using a cubic spline algorithm and subjected to a post-down sampling step in a similar manner to that described above in relation to the GPS locations. This is depicted in FIG. 13.

It will be seen from the above that the device 200 effectively acts as a GNSS odometer that calculates the distance travelled by the wearer of the device using locations and/or speeds obtained from the GPS receiver 204, together with suitable smoothing and filtering techniques. Nevertheless, it will be understood, that there may be tiles during a run or other type of workout when GPS satellite signals cannot be received or can no longer be trusted to be accurate. This can happen, for example, when runners are moving through a dense urban environment. To ensure that the distance will always be accurately determined using even during GPS outage, the device 200 is also provided with a pedometer. The pedometer can be an accelerometer, such as the accelerometer 206, or a footpad sensor, such as 222. If the device has access to both such devices, then typically the footpad sensor 222 is used as the pedometer, since it will typically be more accurate than the accelerometer 206.

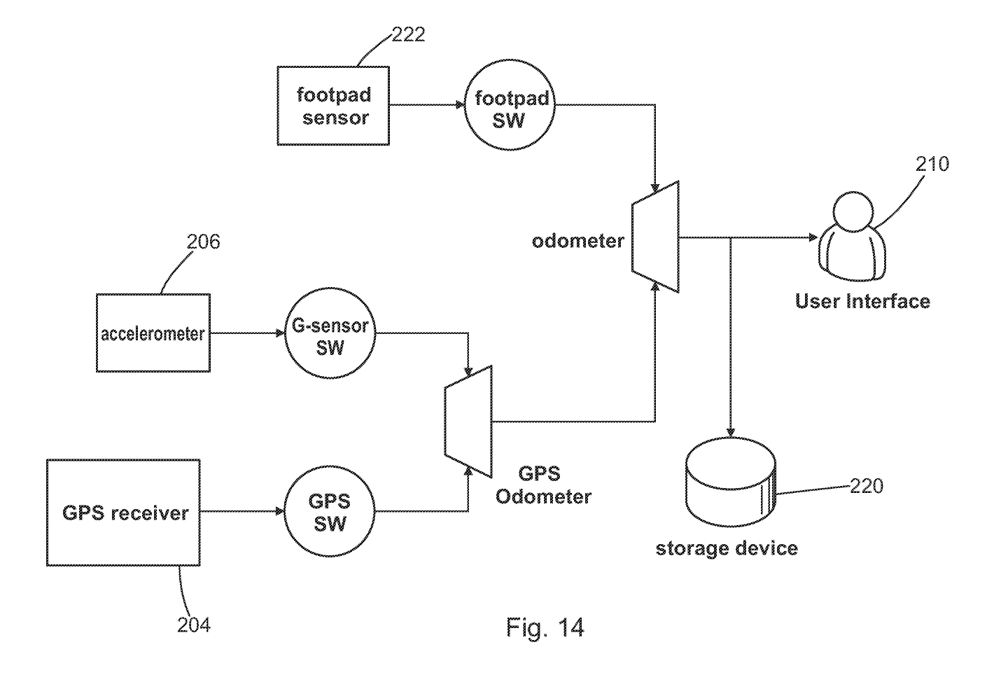

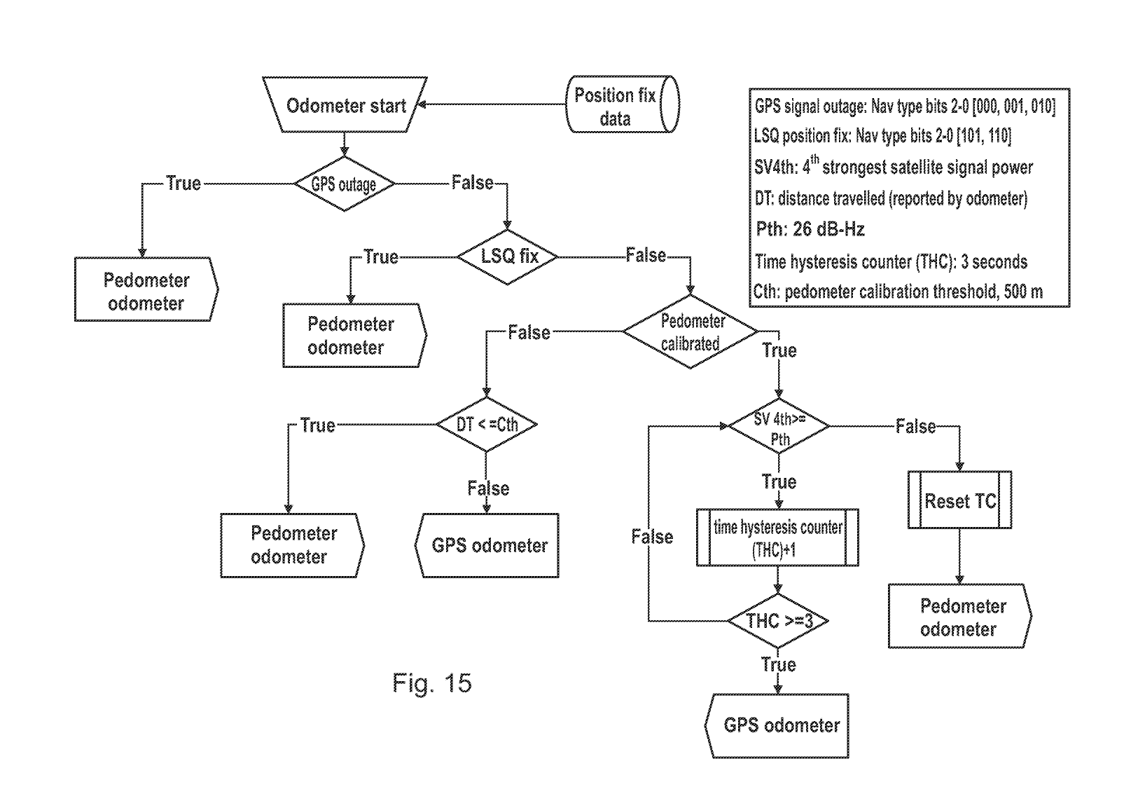

If the GNSS signal is available and measurement quality is of a suitable level, then the odometer, i.e. the device 200, will calculate the distance using the techniques described above. When there is a GNSS signal outage, or the signal can no longer be trusted, then the odometer output is taken over by the pedometer. The system architecture associated with the device 200 is shown in FIG. 14. The way in which the device 200 chooses when to use the GPS odometer or the pedometer odometer is shown in FIG. 15.

As will be appreciated, to ensure that an accurate distance is determined from the pedometer, it needs to be calibrated. The calibrated can be carried out manually, e.g. by the wearer using the pedometer over a known distance such as the 400 m of a running track. In this embodiment shown, however, the calibration is performed automatically using the output of the GPS odometer obtained before the GPS outage.

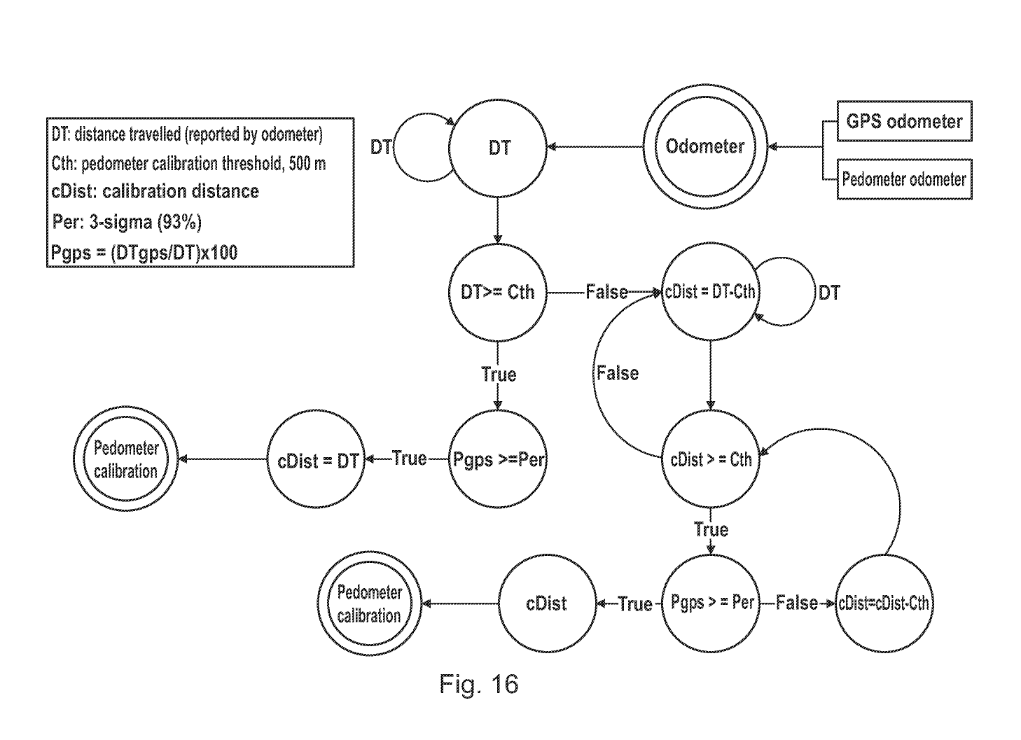

The calibration is performed all the time there is a good quality GPS signal. For example, each time the wearer travels a predetermined distance, such as 500 m, with good GPS signal, e.g. whenever more than 4 satellites can be seen, then a calibrated distance per step can be calculated using the number of steps as counted by the pedometer. This calibrated distance per step is stored on the device 200, e.g. in the memory 220, and continually updated such that the stored value represents the latest dynamical movements of the wearer. The calibration algorithm used in the device 200 is shown in detail in FIG. 16.

In summary, the device 200 functions an odometer that can accurately determine the distance travelled by the user (or the wearer in the case of the device 200 being a watch 300) using data obtained from one or more of a GPS receiver 204, an accelerometer 206 and a footpad sensor 222.

It will also be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, whilst embodiments described in the foregoing detailed description refer to GPS, it should be noted that the navigation device may utilise any kind of position sensing technology as an alternative to (or indeed in addition to) GPS. For example, the navigation device may utilise other global navigation satellite systems, such as the European Galileo system. Equally, it is not limited to satellite-based systems, but could readily function using ground-based beacons or other kind of system that enables the device to determine its geographic location.

It will also be well understood by persons of ordinary skill in the art that whilst the preferred embodiment may implement certain functionality by means of software, that functionality could equally be implemented solely in hardware (for example by means of one or more SICs (application specific integrated circuit)) or indeed by a mix of hardware and software.

Lastly, it should be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specially enumerated in the accompanying claims at this time.

1. A system configured to be transported, carried or worn by a user, comprising:
a location determining device for determining the location of the user at a plurality of times during a journey from a first location to a second location;
at least one motion sensor for determining a motion state of the user at a plurality of times during the journey; and
a processor coupled to the location determining device and the at least one motion sensor, said processor being arranged to determine the distance travelled by the user during at least a portion of the journey using the plurality of determined locations and the plurality of determined motion states.

2. The system of claim 1, wherein the at least one motion sensor comprises an accelerometer.

3. The system of claim 1, wherein the location determining device comprises a global navigation satellite system (GNSS) receiver.

4. The system of claim 1, wherein the at least one motion sensor is arranged to determine whether the user is in one or more of a plurality of predefined motion states.

5. The system of claim 4, wherein the predefined motion states are each indicative of at least one of a speed and type of directional movement of the user.

6. The system of claim 1, wherein the location of the user is determined at a first frequency and the motion state of the user is determined at a second frequency, said first frequency being greater than said second frequency.

7. The system of claim 1, wherein the processor is arranged to determine the distance travelled by the user by sampling determined locations of the user at a sampling rate based on the determined motion state of the user at said locations.

8. The system of claim 7, wherein the at least one motion sensor is arranged to determine whether the user is in one or more of a plurality of predefined motion states, each motion state having an associated sampling rate.

9. The system of claim 1, wherein the location determining device comprises a global navigation satellite system (GNSS) receiver, and the processor is arranged to determine the distance travelled by the user by sampling determined locations of the user at a sampling rate based on the determined motion state of the user and at least one of an accuracy and reliability property of the GNSS receiver at said locations.

10. The system of claim 7, wherein the processor is further arranged to:
apply a smoothing function to the sampled locations to generate a smooth curve associated with the sampled locations; and
sample the smooth curve to determine a plurality of adjusted locations.

11. The system of claim 10, wherein the smooth curve is sampled at a rate selected by the user.

12. The system of claim 10, wherein the processor is arranged to determine the distance travelled by the user by summing the distances between the plurality of adjusted locations.

13. The system of claim 1, further comprising a speed determining device for determining the speed of the user at a plurality of times during the journey, and wherein the processor is arranged to determine the distance travelled by the user during at least a portion of the journey using the plurality of determined speeds.

14. A system configured to be transported, carried or worn by a user, comprising:
a location determining device for determining the location of the user at a plurality of times during a journey from a first location to a second location;
a speed determining device for determining the speed of the user at a plurality of times during the journey;
at least one motion sensor for determining a motion state of the user at a plurality of times during the journey; and
a processor coupled to the location determining device, the speed determining device and the at least one motion sensor, said processor being arranged to determine the distance travelled by the user during at least a portion of the journey by selectively using the plurality of determined locations or the plurality of determined speeds based on the determined motion state of the user.

15. The system of claim 14, comprising a global navigation satellite system (GNSS) receiver, the GNSS receiver being the location determining device and the speed determining device.

16. (canceled)

17. A method of determining the distance travelled by a user during at least a portion of a journey from a first location to a second location using a system configured to be transported, carried or worn by a user, the method comprising:
determining the location of the user at a plurality of times during the journey;
determining a motion state of the user at a plurality of times during the journey; and
using the plurality of determined locations and the plurality of determined motions states to determine the distance travelled by the user.

18. A method of determining the distance travelled by a user during at least a portion of a journey from a first location to a second location using a system configured to be transported, carried or worn by a user, the method comprising:
determining a motion state of the user at a plurality of times during the journey; and
selectively using one of: (i) a plurality of locations of the user during the journey; and (ii) a plurality of speeds of the device during the journey, to determine the distance travelled by the user based on the determined motion states of the user.

19. The system of claim 7, wherein the at least one motion sensor is arranged to determine whether the user is in one or more of a plurality of predefined motion states, each combination of motion states having an associated sampling rate.

20. The system of claim 10, wherein the smooth curve is sampled at a rate based on the determined motion state of the user.
